(19) United States
(12) Patent Application Publication
(10) Pub. No.: US 2019/0151875 A1
(43) Pub. Date: May 23, 2019

(54) FLUID DISPENSER

(71) Applicant: Leafgreen Limited, Wollaston, Stourbridge, West Midlands (GB)

(72) Inventor: Keith LAIDLER, Wollaston, Stourbridge, West Midlands (GB)

(21) Appl. No.: 15/571,349

(22) PCT Filed: Apr. 28, 2016
(86) PCT No.: PCT/GB2016/051203

§ 371 Date: Nov. 2, 2017

(30) Foreign Application Priority Data
May 6, 2015 (GB) 1507870.2
Oct. 22, 2015 (GB) 1518715.6

(51) Int. Cl. B05B 11/00

(52) U.S. Cl. CPC B05B 11/304; B05B 11/3073; B05B 11/3011; B05B 11/0067

(57) ABSTRACT

A nozzle arrangement adapted for a pump dispenser, e.g. a manually-operated pump dispenser, that is activated by an actuation stroke of an actuator or a trigger handle to dispense a fluid from a container as a spray, e.g. an atomised spray, a foam, a gel, a paste or a liquid, wherein the nozzle arrangement is positioned downstream of, and in fluid communication with, a pump chamber of the dispenser and the nozzle arrangement comprises: an expansion chamber having an inlet and an outlet; and a movable plunger disposed within the expansion chamber, the movable plunger being arranged such that it can move, in use, in an upstream and downstream direction to vary the volume of the expansion chamber, wherein the plunger is biased by a resiliently deformable component such as a spring, the resiliently deformable component providing a biasing force in the downstream direction; wherein, in use, the actuation stroke causes the fluid to enter the expansion chamber at a faster rate than the fluid can be discharged from the expansion chamber via the outlet, whereby a pressure build-up within the expansion chamber pushes the plunger in the upstream direction against the biasing force provided by the resiliently deformable component such that fluid entering the expansion chamber is discharged via the outlet during the actuation stroke and after the actuation stroke, due to the biasing force provided by the resiliently deformable component causing the plunger to move in the downstream direction, thereby causing fluid to be discharged via the outlet.

The present invention relates, in particular, to manually actuated pump type fluid dispensers including those operated by a trigger handle or actuator.

Manually actuated pump type fluid dispensers are commonly used to provide a means by which fluids can be dispensed from a non-pressurised container. Typically, dispensers of this kind have a pump arrangement which is located above the container when in use. The pump includes a pump chamber connected with the container by means of an inlet having an inlet valve and with a dispensing outlet via an outlet valve. To actuate the dispenser, a user manually applies a force to an actuator to reduce the volume of the pump chamber and pressurise the fluid inside. Once the pressure in the chamber reaches a pre-determined value, the outlet valve opens and the fluid is expelled through the outlet. When the user removes the actuating force, the volume of the chamber increases and the pressure in the chamber falls. This closes the outlet valve and draws a further charge of fluid up into the chamber through the inlet. A range of fluids can be dispensed this way including pastes, gels, liquid foams and liquids. In certain applications, the fluid is dispensed in the form of an atomised spray, in which case the outlet will comprise an atomising nozzle. The actuator may be a push button or cap, though in some applications the actuator arrangement includes a trigger that can be pulled by a user's fingers.

A large number of commercial products are presented to consumers in a manual pump type dispenser, including, for example, tooth paste, antiperspirant, de-odorant, perfumes, air fresheners, antiseptics, paints, insecticides, polish, hair care products, pharmaceuticals, shaving gels and foams, water and lubricants.

There are numerous types of manually activated pumps and triggers on the market and they are sold in enormous volumes especially through the major retailers such as supermarkets. Consequently, they are very inexpensive and there is little profit in them for the manufacturers. This makes it difficult to justify paying out large sums of money to develop new ones. One of the biggest drawbacks with pumps and triggers is the fact that they deliver intermittent discharges of fluid rather than a continuous discharge. Generally they deliver a disc shaped spray or foam or a bolus of fluid. So, if someone sprays onto a wall or onto furniture they produce a series of discs with some overlapping in parts and gaps between them. Similarly, if you spray into the air with an air treatment such as air freshener, you don't achieve an even coverage when you spray. A better alternative is to deliver a continuous spray or foam so that a much more even coverage is attained. The problem is how to do this at a low cost and make it reliable and user friendly.

There are continuous pumps, triggers and dispensers on the market that use pressurized containers where the user pumps air into the canister and continues to do so until a sufficient pressure has been reached and the fluid is then driven out by the compressed air. These work well but they tend to be too costly and bulky. There is a type of continuous trigger on the market disclosed in patent application WO2014074654 A1 where there is a buffer chamber created and this buffer chamber is pressurized to produce a continuous spray. Air is pressurized to affect the control. Hence, this trigger requires a special bottle and that makes it quite expensive.

It would be desirable for a continuous pump, trigger or dispenser to be available that could be used with a non-pressurised container.

A problem with conventional triggers and dispensers that deliver a discharge per actuation stroke is that the liquor is forced through a small orifice and usually a swirl feature in a very short time. This means a lot of force is used and it also produces a poor spray and foam. Yet if that same discharge were produced during the actuation stroke and some or all of a return stroke, the force could potentially be reduced and the spray and foam enhanced. Currently, known devices either do continuous discharges or discharge during the actuation stroke, but not during both strokes (i.e. the actuation stroke and the return stroke). It isn't straightforward either because the quality of the spray and foam varies considerably during both strokes so additional functionality has to be added to the devices to counter that problem. Having an extended spray time enables a smaller orifice to be used and that normally produces finer droplets or foam. It also means that the user is filling up some of the chamber as he actuates rather than forcing the fluid through a small orifice and that the user can use less actuation force or the precompression setting can be raised and the same force is required. Generally, the higher the precompression the finer the spray droplets or foam.

It would be desirable to provide a continuous pump, trigger or dispenser that is also operable to deliver an intermittent discharge per actuation stroke as normal so the user can choose which mode of operation to use and when.

Our solution to one or more, e.g. some or all, of these problems is a nozzle arrangement that can be adapted to conventional manually activated dispensers or triggers with non-pressurized containers to convert them into devices that deliver a continuous discharge, a standard discharge or an extended but not continuous discharge. Typically, the user may be able to switch easily the device from one variant or mode of operation to another. Advantageously, the nozzle arrangement may be simple to make and may be very low cost with a small net increase in components and/or complexity compared with a conventional dispenser or trigger. Conveniently, conventional dispensers or triggers can be altered to use the invention or new devices that include it can be developed instead. In an ideal world it is very desirable to be able to convert a standard dispenser or trigger into a variable function version as it costs multi millions to set up a manufacturing line for the devices. Also, companies tend to have a number of types and sizes of such devices so the cost of changing over to continuous devices is prohibitive. Sometimes companies only want to use one or more of the different functions and may choose not to make all of them available to the user. Perhaps they will only be continuous discharge or maybe continuous and intermittent; and so on. Advantageously, the nozzle arrangement of the present invention may be manufactured on a conventional or pre-existing manufacturing line, with few, minimal or even no modifications and/or additions to the manufacturing line.

For continuous discharges, the requirement is for a device that is still actuated as normal and it starts discharging during the first actuation and then sprays as the user continues to actuate it. You want it to continue discharging when the user activates it slowly or quickly and gently or aggressively with full or short strokes. You also want a fairly consistent quality of foam or spray, a fairly consistent flow and you want no or minimal increases in the actuation force. The last thing that you want is to stop pulling the handle or pressing down on the actuator and to have the device continuing to discharge for a protracted time. The cost has to be very low. These are demanding requirements but, with the present invention, we have achieved one or more, typically all, of them.

According to a first aspect of the invention there is provided a nozzle arrangement adapted for a pump dispenser, e.g. a manually-operated pump dispenser, that is activated by an actuation stroke of an actuator or a trigger handle to dispense a fluid from a container as a spray, e.g. an atomised spray, a foam, a gel, a paste, a jet or a liquid, wherein the nozzle arrangement is positioned downstream of, and in fluid communication with, a pump chamber of the dispenser and the nozzle arrangement comprises: an expansion chamber having an inlet and an outlet; and a movable plunger disposed within the expansion chamber, the movable plunger being arranged such that it can move, in use, in an upstream and downstream direction to vary the volume of the expansion chamber, wherein the plunger is biased by a resiliently deformable component such as a spring, the resiliently deformable component providing a biasing force in the downstream direction; wherein, in use, the actuation stroke causes the fluid to enter the expansion chamber at a faster rate than the fluid can be discharged from the expansion chamber via the outlet, whereby a pressure build-up within the expansion chamber pushes the plunger in the upstream direction against the biasing force provided by the resiliently deformable component such that fluid entering the expansion chamber is discharged via the outlet during the actuation stroke and after the actuation stroke, due to the biasing force provided by the resiliently deformable component causing the plunger to move in the downstream direction, thereby causing fluid to be discharged via the outlet.

Advantageously, the nozzle arrangement may convert pumped or intermittent discharges from the dispenser into an extended and/or continuous discharge that continues after completion of the actuation stroke of the actuator or trigger handle. Accordingly, the nozzle arrangement may provide a more consistent and/or longer-lasting discharge per actuation stroke.

In an embodiment, the movable plunger may have a downstream end that seals off the outlet in an off or a rest position.

The nozzle arrangement may comprise a valve that is configured to allow some fluid to flow from the expansion chamber to the pump chamber or the or a container once a set volume has been exceeded.

In an embodiment, the expansion chamber may be configured to have a maximum storage capacity for fluid that is less than three times the capacity of the pump chamber. Preferably, the expansion chamber may be configured to have a maximum storage capacity for fluid that is less than the capacity of the pump chamber.

In an embodiment, the outlet from the expansion chamber may be in fluid communication with at least one final orifice. In use, the fluid may be discharged through the at least one final orifice.

In an embodiment, the nozzle arrangement may be configured such that the rate of flow of the fluid out of the outlet or the final orifice(s) is less than ⅓ of the rate of flow of the fluid from the pump chamber into the expansion chamber.

In an embodiment, the nozzle arrangement may comprise a flow controller disposed downstream of the pump chamber and upstream of the outlet or the final orifice(s).

The nozzle arrangement may be configured to provide an extended and/or continuous discharge, which lasts for more than 0.3 seconds after the actuation stroke.

In an embodiment, the nozzle arrangement may be configured to provide an extended and/or continuous discharge, which lasts for less than or more than 1.3 seconds after the actuation stroke.

Preferably, the trigger or pump should still be able to deliver an intermittent discharge per stroke as normal so the user can choose which mode of operation to use and when. Preferably, there should be an easy way to switch between the two different functions.

In an embodiment, the nozzle arrangement may comprise an adaptor disposed downstream of the outlet, the adaptor being operable in a first position to enable the nozzle arrangement to discharge the fluid as a continuous and/or extended spray or foam, and in a second position to enable the nozzle arrangement to discharge the fluid as a standard or non-continuous spray or foam. The adaptor may be movable, e.g. rotatable, from the first position to the second position and vice versa.

According to a second aspect of the present invention there is provided a nozzle arrangement adapted for a pump dispenser, e.g. a manually operated pump dispenser, that is activated by an actuator or a trigger handle for dispensing a fluid from a container as an atomised spray or a foam, the nozzle arrangement converting the pumped or intermittent discharges from the dispenser into an extended discharge that continues after an actuation stroke of the pump dispenser, whereby the nozzle arrangement is positioned downstream of a pump chamber of the dispenser and comprises an expansion chamber with a variable storage capacity for the fluid, an outlet downstream of the expansion chamber, a moveable plunger inside the expansion chamber that is tensioned by a resiliently deformable component such as a spring and that moves further upstream as the expansion chamber fills with fluid.

According to a third aspect of the present invention there is provided a nozzle arrangement adapted for a pump dispenser, e.g. a manually operated pump dispenser, that is activated by an actuator or a trigger handle for dispensing a fluid from a container as an atomised spray or a foam, the nozzle arrangement converting the pumped or intermittent discharges from the dispenser into an extended discharge that continues after the actuation stroke of the pump dispenser, whereby the nozzle arrangement is positioned downstream of the pump chamber of the dispenser and comprises an expansion chamber with a variable storage capacity for the fluid, an outlet downstream of the expansion chamber, a moveable plunger inside that chamber that is tensioned by a resiliently deformable component such as a spring and that moves further upstream as the expansion chamber fills with fluid whereby the discharges are continuous.

According to a fourth aspect of the present invention there is provided a nozzle arrangement adapted for a pump dispenser, e.g. a manually operated pump dispenser, that is activated by an actuator or a trigger handle for dispensing a fluid from a non-pressurized container, the nozzle arrangement converting the pumped or intermittent discharges from the dispenser into a continuous discharge, whereby the nozzle arrangement is positioned downstream of the pump chamber of the dispenser and comprises an expansion chamber with a variable storage capacity for the fluid, an outlet downstream of the expansion chamber, a moveable plunger inside that chamber that is tensioned by a resiliently deformable component such as a spring and that has a downstream end that seals off the outlet in the off position and that moves further upstream as the expansion chamber fills with fluid and there is a valve between the two parts that allows some fluid to flow from the expansion chamber to the pump chamber or the container once a set volume has been exceeded.

According to a fifth aspect of the present invention there is provided a nozzle arrangement adapted for a pump dispenser, e.g. a manually operated pump dispenser, that is activated by an actuator or a trigger handle for dispensing a fluid from a non-pressurized container, the nozzle arrangement converting the pumped or intermittent discharges from the dispenser into a continuous discharge, whereby the nozzle arrangement is positioned downstream of the pump chamber of the dispenser and comprises an expansion chamber with a variable storage capacity for the fluid, an outlet downstream of the expansion chamber, a moveable plunger inside that chamber that is tensioned by a resiliently deformable component such as a spring and that has a downstream end that seals off the outlet in the rest position and that moves further upstream as the expansion chamber fills with fluid whereby there is a maximum storage capacity for fluid in the chamber that is less than three times the capacity of the pump chamber and preferably less than one time.

According to a sixth aspect of the present invention there is provided a nozzle arrangement adapted for a pump dispenser, e.g. a manually operated pump dispenser, that is activated by an actuator or a trigger handle for dispensing a fluid from a non-pressurized container, the nozzle arrangement converting the pumped or intermittent discharges from the dispenser into a continuous discharge, whereby the nozzle arrangement is positioned downstream of the pump chamber of the dispenser and comprises an expansion chamber with a variable storage capacity for the fluid, an outlet downstream of the expansion chamber, a moveable plunger inside that chamber that is tensioned by a resiliently deformable component such as a spring and that has a downstream end that seals off the outlet in the rest position and that moves further upstream as the expansion chamber fills with fluid whereby the rate of flow of the fluid out of the final orifice is less than ⅓ the flow from the pump chamber

According to a seventh aspect of the present invention there is provided a nozzle arrangement adapted for a pump dispenser, e.g. a manually operated pump dispenser, that is activated by an actuator or a trigger handle for dispensing a fluid from a non-pressurized container, the nozzle arrangement converting the pumped or intermittent discharges from the dispenser into a continuous discharge, whereby the nozzle arrangement is positioned downstream of the pump chamber of the dispenser and comprises an expansion chamber with a variable storage capacity for the fluid, an outlet downstream of the expansion chamber, a moveable plunger inside that chamber that is tensioned by a resiliently deformable component such as a spring and that has a downstream end that seals off the outlet in the rest position and that moves further upstream as the expansion chamber fills with fluid whereby the rate of flow of the fluid out of the final orifice is controlled by a flow controller upstream of the final outlet orifice and downstream of the pump chamber.

According to an eighth aspect of the present invention there is provided a nozzle arrangement adapted for a pump dispenser, e.g. a manually operated pump dispenser, that is activated by an actuator or a trigger handle for dispensing a fluid from a non-pressurized container, the nozzle arrangement converting the pumped or intermittent discharges from the dispenser into a continuous discharge, whereby the nozzle arrangement is positioned downstream of the pump chamber of the dispenser and comprises an expansion chamber with a variable storage capacity for the fluid, an outlet downstream of the expansion chamber, a moveable plunger inside that chamber that is tensioned by a resiliently deformable component such as a spring and that has a downstream end that seals off the outlet in the rest position and that moves further upstream as the expansion chamber fills with fluid whereby the discharge after the actuation stroke is more than 0.3 seconds.

According to a ninth aspect of the present invention there is provided a nozzle arrangement adapted for a pump dispenser, e.g. a manually operated pump dispenser that is activated by an actuator or a trigger handle for dispensing a fluid from a non-pressurized container, the nozzle arrangement converting the pumped or intermittent discharges from the dispenser into a continuous discharge, whereby the nozzle arrangement is positioned downstream of the pump chamber of the dispenser and comprises an expansion chamber with a variable storage capacity for the fluid, an outlet downstream of the expansion chamber, a moveable plunger inside that chamber that is tensioned by a resiliently deformable component such as a spring and that has a downstream end that seals off the outlet in the rest position and that moves further upstream as the expansion chamber fills with fluid whereby the final discharge after the actuation stroke is less than 1.3 seconds.

According to a tenth aspect of the invention there is a provided a fluid dispenser comprising a nozzle according to any one of the first to ninth aspects of the invention.

Typically, the dispenser may comprise a container. Conveniently, the container may be a non-pressurised container.

The container may contain a fluid. For example, the fluid may comprise tooth paste, antiperspirant, de-odorant, perfume, air freshener, antiseptic, paint, insecticide, pesticide, polish, a hair care product, a pharmaceutical, shaving gel or foam, water or lubricant.

According to an eleventh aspect of the present invention there is provided a manually operated pump dispenser that is activated by an actuator or a trigger handle for dispensing a fluid continuously from a container, whereby the pump dispenser includes a flow controller upstream of a final orifice and downstream of the pump chamber that regulates the flow as the pressure varies.

According to a twelfth aspect of the present invention there is provided a manually operated pump dispenser that is activated by an actuator or a trigger handle for dispensing a fluid continuously from a container, whereby the pump dispenser includes a an expansion chamber and there is a valve that is configured to allow some fluid to flow back to the pump chamber or container once a set pressure has been exceeded.

According to a thirteenth aspect of the present invention there is provided a manually operated pump dispenser that is activated by an actuator or a trigger handle for dispensing a fluid continuously from a container, whereby the pump dispenser includes an expansion chamber and there is an outlet nozzle that can be rotated into different set positions wherein at least one of the positions enables the device to deliver a continuous spray or foam and at least one of the other positions enables the device to deliver a standard or none continuous spray or foam.

A further aspect of the invention provides a use of a nozzle arrangement of any one of the first to ninth aspects of the invention or a dispenser of any one of the tenth to thirteenth aspects of the invention to discharge a fluid.

Several embodiments of the invention will now be described, by way of example only, with reference to the accompanying drawings, in which:

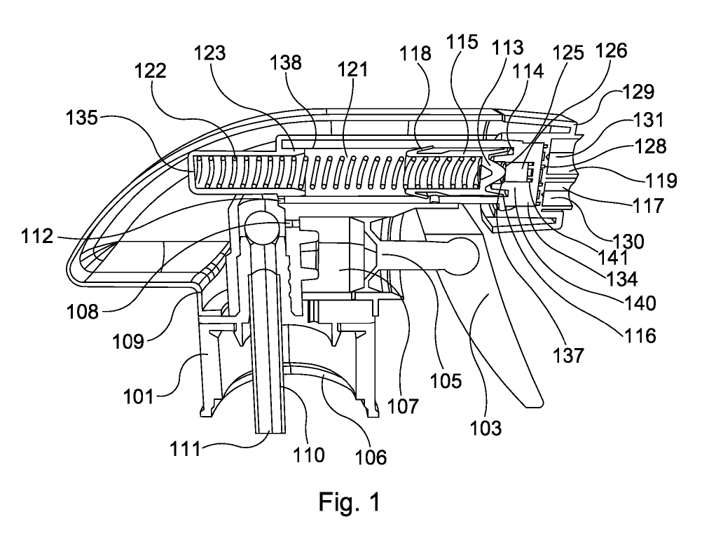

FIG. 1 is a cross-sectional view of a dispenser pump actuated with a trigger including an example embodiment of a nozzle arrangement in accordance with the invention;

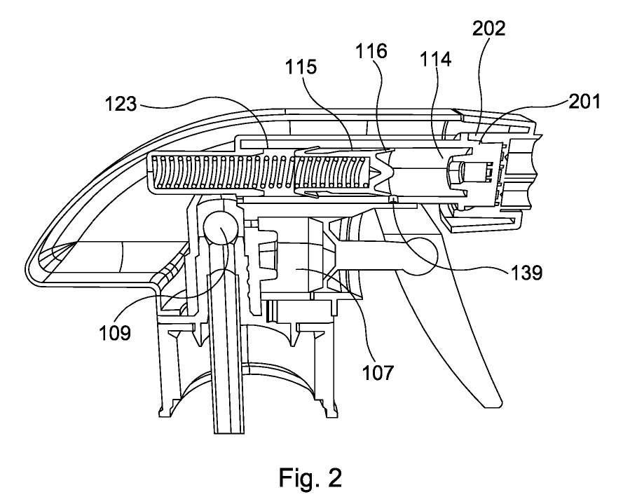

FIG. 2 is a view similar to that of FIG. 1 but showing the plunger with the inlet valve in the fully extended position;

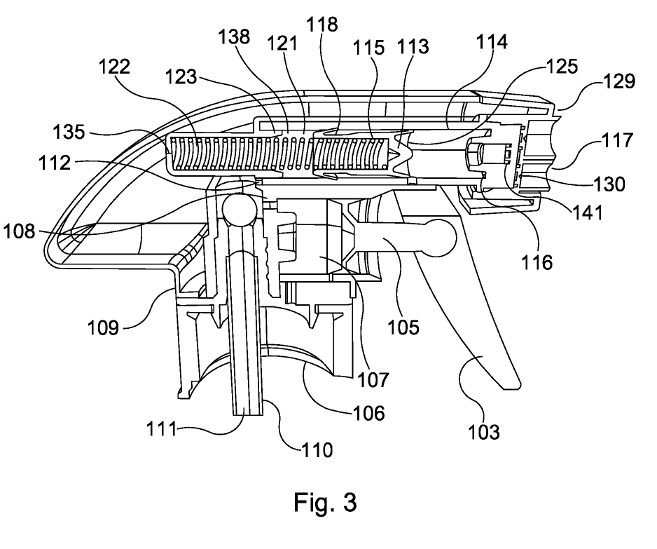

FIG. 3 is a view similar to that of FIG. 1 but showing the plunger with the inlet valve in the just open position,

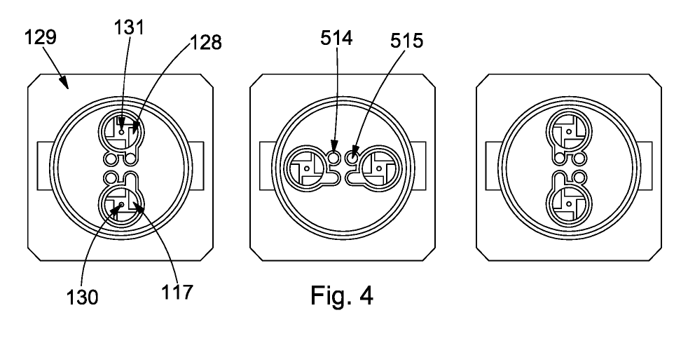

FIG. 4 is a view of a preferred downstream face of the nozzle showing how it functions,

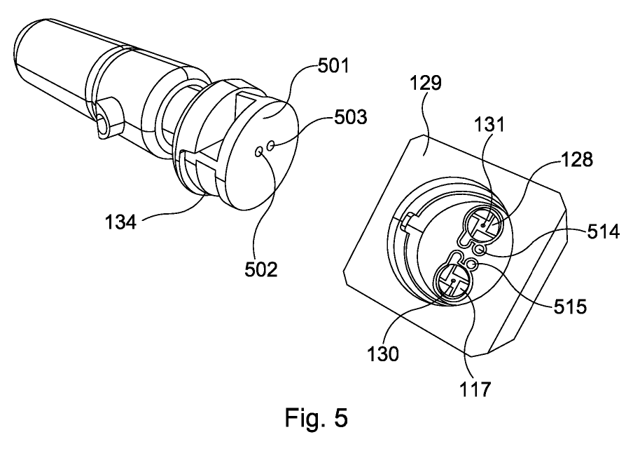

FIG. 5 is a view of a preferred configuration of the nozzle and nozzle post,

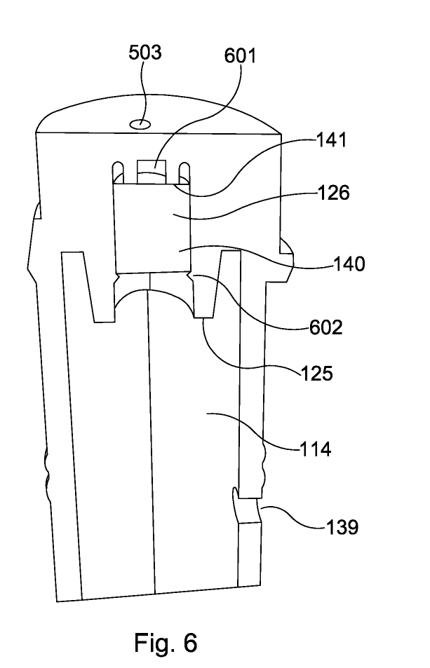

FIG. 6 is a cross-sectional view of a preferred nozzle and flow controller,

FIGS. 1-6 show a first embodiment of a manually actuated pump dispenser with a trigger in accordance with the invention. The nozzle arrangement itself comprises the following component parts, an expansion chamber 121 open to the atmosphere at the upstream end and having a wall at the downstream end with a delivery outlet 125, a first expansion chamber 114, a plunger 115 with an integral prodder 113, a one way valve 116 and a seal 118, a spring 122, a nozzle 129, a feature including a swirl chamber 128 and inlet holes 502, 503 on a post 134, and a flow controller 126. The nozzle arrangement has an inlet 112 from the outlet tube 108 downstream of the pump chamber 107, an upstream end 123 open to the atmosphere via a hole 135, a downstream chamber 137 for the flow controller 126, a downstream nozzle post 134 and a rotateable nozzle 129 usually incorporating a swirl 128 and fixed onto the post 134. Inside the expansion chamber 121 there is a plunger 115 with a downstream prodder part 113 that seals the outlet tube 125 on the expansion chamber 121 downstream end wall in its furthest downstream position. The plunger 115 has an upstream seal 118 that seals between the plunger 115 and wall 138 of the expansion chamber 121. The upstream seal 118 splits the expansion chamber 121 and creates a first expansion chamber 114 that is downstream of the expansion chamber 121 and downstream of the upstream seal 118. The first chamber 114 contains any fluid whereas the expansion chamber 121 only contains air at ambient pressure. A resiliently deformable component 122 that is normally a spring is positioned between the upstream end of the plunger 115 and the upstream end 123 of the expansion chamber 121. There is an inlet 112 from the tube 108 following the pump chamber 107 and this opens into the first expansion chamber 114 at 139. There is a one way valve 116 between the pump chamber 107, the inlet 139 and the first expansion chamber 114 that allows fluid to flow to the first expansion chamber 114 from the pump chamber 107 but prevents anything returning in normal use. In a preferable version this valve is formed as part of the plunger 115 and comprises a seals 116 and the main seal 118 on the plunger 115 prevents fluid getting into the expansion chamber 121. These seals are configured so that the main seal is always upstream of the inlet hole 139 to the first expansion chamber 114 and the downstream valve seal 116 is downstream of the inlet hole 139 in the rest position and in normal use of the device. They form annular seals between the plunger 115 and the first expansion chamber 114 side walls and the downstream seal 116 acts as a valve for the inlet hole 139 letting fluid flow into the first expansion chamber 114 whilst preventing it leaving in normal use. But when the plunger 115 has moved upstream to the required position, the downstream seal 116 exposes the inlet hole 139 to the fluid in the first expansion chamber 114 by moving upstream of at least part of the inlet hole 139. This often causes a reduction in pressure in the first expansion chamber 114 as some of the fluid can pass back to either the pump chamber 107 or to the container. As soon as that happens, the plunger 115 quickly moves downstream because of the influence of the spring and the discharge through a final orifice such as 131 and the seal 116 goes downstream of the inlet hole 139 parenting fluid from flowing back from the first expansion chamber 114. When the inlet hole is exposed the fluid will flow to the pump chamber 107 if the pump is on the return stroke as it will draw some of the fluid from the first expansion chamber 114 in preference to from the container as it is pressurized. But there can also be a high pressure valve to the container that allows a controlled volume of liquor back into the container once a set pressure has been reached. This could be instead of the inlet valve 109 shown as a simple one way ball valve modified to both allow fluid in to the device and prevent fluid returning to the container unless a set pressure has been exceeded. This high pressure valve will not be necessary for some designs. The maximum pressure in the first expansion chamber 114 is partly determined by the distance that the plunger 115 moves upstream and the strength of the spring 122 in that position. If there was no high pressure valve or positional valve between the pump chamber 107 and the first expansion chamber 114, this pressure could become very high. This arrangement ensures that there is never too much fluid in the first expansion chamber 114 and that the pressure in it never exceeds a set pressure. The seal 116 can pass the inlet hole 139 and move further upstream and if there is enough movement then the excess fluid can be simply returned to the pump chamber 107 ensuring that the pressure is never excessive.

In a preferred version as seen in FIGS. 1 and 6 there is also a flow controller 126 inside the tubular chamber 140. A number of different types of flow controllers would suffice but we have used a known cheap, simple, small and effective design with a resiliently deformable flat disc or rod 126 on the upstream edge of a tube 141 inside a tube 140. In the upstream edge of the tube 141 we add a recess or recesses or raised ribs or surface texture or the V shaped groove 601 shown in FIGS. 6 to ensure a flow of the fluid between the rod 126 and the tube 141 that varies according to the pressure of the fluid. The fluid flows past the rod 126 and though the V groove 601 and then out through a hole 502 as shown in FIG. 5 which is in the downstream wall of the nozzle post 134. The fluid can also bypass the flow control and groove 601 and go instead straight through the hole 503 or it can take both routes or it can be blocked and this depends upon if holes 502 and 503 are blocked by the nozzle 129. The flow control 126 is best used with 1 or 2 V shaped grooves such as 601 in the edge of the tube 141 and the rod 126 pushes further into them at higher pressures. The arrangement can be configured so that the flow stays substantially the same regardless of pressure and many applications would be made this way. But in some cases, the flow is allowed to increase as the pressure increases but in a none linear way so that the difference in the flows between the highest and lowest chamber pressures is maintained within set limits which are usually between 20-40% and preferably around 20%. Any suitable range can be achieved. The rod 126 is housed within the outer tube 140 and is able to move freely within it and this means that when the dispenser is moved around or shaken, the rod 126 can come away from the edge of the inner tube 141 and this allows any debris or particles to be cleared and makes the flow control cleanable. A small rim 602 is formed on the inside of the outer tube 140 to prevent the rod 126 from coming out of the tube 140. To attain our optimum profile we need a specifically shaped leak path in the edge of the inner tube 141. The rod 126 is resiliently deformable and with no pressure it has its normal shape and sits within the outer tube 140. The fluid pushes the rod 126 onto the edge of the inner tube 14 land as the pressure increases so it is deformed more into the groove 601 reducing the gap and restricting the flow. Varying the hardness of the rod 126 or the size and shape of the grooves or deformations varies the leak rate and the profile of the leak rate.

In FIGS. 1, 2 and 3 we see 3 different operational positions of the plunger. The closed position in FIG. 1 occurs when the device isn't being used or before the pressure has built up enough to actuate the device. So the prodder 137 is sealing the tube outlet 125 from the first expansion chamber 114 and there is no flow out of the final orifice 131. In the normal operating position the plunger 115 has moved upstream of the rest position and the prodder 137 no longer seals the outlet 125. Fluid flows from the pump chamber 107 to the inlet hole 139, through the one way valve 116 and into the first expansion chamber 114. It also fills up any space downstream of the main seal 118. The fluid flows downstream through the V groove 601 between the flow control rod 126 and the rim of the tube 141 and then to the swirl chamber 128 and out through the orifice 131. Because there is a suitably shaped tube 119 around and downstream of the orifice 131, the output would be in the form of a foam because the spray from the orifice 131 would strike the sides of the tube 119 and this generates foam. Air can also be drawn into the tube 119 through a venturi hole in the wall of the tube. The nozzle has 2 orifices 131, 130 each surrounded by a tube and an additional blank or closed position. The orifice 130 has a different swirl chamber 117. The nozzle 129 can be rotated on the post 134 and can normally be set in 1-4 different positions with the current design shown using 3 different positions. So the fluid can either flow through either hole 503 in the post 134 to swirl chamber 128 to orifice 131 or through hole 502 in the post 134 to swirl chamber 117 to orifice 130, or it is closed off with no flow as shown in FIG. 4 where the holes 502 and 503 line up with the two raised blocking circular seals 414 and 415. This is best seen in FIG. 5 where both swirls are also protected by raised seals. Upstream of the hole 502 is the flow control 126. There is a second route to the hole 503 that bypasses the flow control so it is a higher flow. Hole 503 could be fed from both the bypass and the flow control as could the swirl chamber 117. Normally, if the device is to operate as a standard trigger the discharge is very fast so a larger orifice is needed and the flow through the flow controller isn't normally enough because it is designed for the continuous and extended discharges. So additional flow is needed to the swirl chamber. If a spray is required instead of a foam the tubes such as 119 are either absent, shorter or wider so the spray doesn't hit them. A nozzle that sprays with no tubes is shown in FIG. 2. Sometimes a mesh is used instead of or as well as the tube 119 to create a foam and this is often moved in place using a closed hinged flap for foam or hinged open to the side for spray.

The maximum travel position shown in FIG. 2 shows the plunger 115 as far upstream as it can go because it is prevented from moving any further by the shoulder 123. In this position the one way valve 116 no longer protects the inlet hole 139 to the first expansion chamber 114 and this prevents the pressure building up too high in the first expansion chamber 114 because fluid will now go from the first expansion chamber 114 to the pump chamber 107 on the return stroke or if available it will go through a high pressure return valve between the pump dispenser and the container usually positioned where the ball valve 109 is shown. The ball valve itself could be made to leak above certain pressures by making the edge the ball seals on deformable above set pressures. The pressure in the first expansion chamber 114 also immediately reduces during the pump return stroke because the pressure of all fluid in the system equalizes and that pressure is then lower than the pressure in the first expansion chamber 114 because the spring 122 increases the pressure in the expansion chamber. Simultaneously, fluid is still flowing from the first expansion chamber 114 to the outlet orifice 131 so the plunger 115 quickly moves back downstream with the seal 116 protecting the inlet hole 139. In practice this extreme position isn't normally reached or for only a very short time and it acts as a fail safe to prevent the expansion chamber pressure from going too high and also keeps the pressure within set levels. Also, the inlet hole 139 is exposed before the plunger 115 reaches its maximum travel position and that prevents the pressure from going too high as fluid can be returned to the pump chamber as soon as it is exposed. Restricting the movement of the plunger 115 also controls the maximum over spray time and volume so it is never too long. Once the user stops actuating the device no more fluid enters through the inlet hole 139 and the plunger 115 moves downstream until the prodder reseals the outlet hole 125 and there is no further discharge.

In FIG. 3 we see the plunger 115 in the open position during the actuation pump stroke with the downstream seal 116 just upstream of the inlet hole 139. In normal use, the seal 116 protects the inlet hole 139 so the position of the plunger is somewhere upstream of the position shown in FIG. 1 and downstream of the position shown in FIG. 3.

In FIG. 4 we see the underside or upstream face of the outlet nozzle 129 showing how the nozzle is rotated into different positions to open up either an orifice or to close off the orifices. The two outlet holes 502 and 503 shown on FIG. 5 line up with two different positions on the underside of the nozzle and are represented by the filled in discs. In the middle drawing of FIG. 4, the holes 502 and 503 line up with the sealed rings 514 and 515 so there can be no flow. In the two outer (i.e. left and right) drawings of FIG. 4, one of the outlet holes lines up with a sealed ring and the other lines up with a sealed area leading to one of the orifices 130 or 131. This is one of many configurations that can be used to be able to move between a continuous spray, an extended spray, an intermittent spray and an off position and others if required. The important point is for the user to be able to simply use either a standard trigger discharge or a continuous discharge or an extended discharge.

In FIG. 5 we see a preferred configuration of the nozzle 129 and post 134 arrangement shown in FIG. 4 where the swirls are on the upstream side of the nozzle 129 and the outlets from the post 134 are just holes in the downstream end of the post 134. This reduces the difficulty of sealing between the two components which are normally snap fitted together fixing them in place with the raised circumferential ridge 201 on the post 134 in the circumferential groove 202 in the nozzle 129 but still enabling the nozzle 129 to rotate into different positions on the post 134 As described previously, there could be 1-3 different swirls and one closed position or even 4 different swirls. More than one nozzle orifice could be made to produce a continuous spray and they could all follow the flow controller and varying the sizes of the orifices will vary the over spray time. There could also be no flow controller with one or more routes. Another possibility is to have just one swirl chamber and spray orifice on the nozzle 129 and to rotate the nozzle on the post in such a way that different routes with different flow rates through the post 134 are open to the swirl chamber. The swirl chamber could even be on the post 134 instead. There are other configurations that could be used and these are just some of our preferred options but we are not confined to them.

The form of the outlet nozzle orifice 131 varies according to whether the discharge is a spray, a foam or a jet. For foam and sprays there is usually a swirl chamber 128 immediately preceding the final orifice 131 but any configuration that makes the fluid spin and atomizes the spray could be used instead. For a foam there is usually also an open ended tube around and downstream of the final orifice with side inlet holes in the upstream tube wall to allow air to be drawn into the tube as the device is actuated. The tube is configured so that the spray hits the side of the tube wall and this creates a foam. Sometimes there is also a mesh in or on the end of the tube and this can be folded over when foam is required. Sometimes there is just the mesh and no tube. For atomised sprays there may still be a tube around the final orifice but it is designed not to impinge on the spray. The nozzle configuration in FIG. 1 would produce a foam and in FIG. 2 would produce an atomized spray.

In operation, when the user actuates the dispenser or trigger, the pump chamber 107 is discharged and when it is released the pump chamber 107 automatically refills usually because of a spring acting upon the pump plunger 105 until the user then activates it again emptying the pump chamber 107. This process continues until the user stops altogether and the last part of the cycle is where the pump chamber 107 refills. The prodder 137 initially seals the expansion chamber outlet hole 125 and when the dispenser is activated, fluid passes from the pump chamber 107 to the expansion chamber 114 via the one way valve 116. It first fills up any dead space in the first expansion chamber 114 and exerts an upstream force on the plunger 115 which is counteracted by the spring 122 keeping the outlet hole 125 sealed. The pressure of the fluid entering into the first expansion chamber 114 quickly increases and exceeds the force of the spring 122 and causes the prodder 137 to be moved away from the outlet hole 125. Some fluid will be discharged from the final orifice 131 almost as soon as the prodder 137 no longer seals the hole 125 but the flow out of the final orifice 131 is less than the flow of the fluid entering into the first expansion chamber 114 so the plunger and prodder combination 115 moves further upstream. Once the pump chamber 107 has been discharged, no more fluid enters into the first expansion chamber 114 so the plunger moves downstream until the prodder seals the hole. For our standard discharge version the prodder will seal the hole substantially at the same time as the pump chamber is discharged. For the extended version the prodder won't seal the hole until sometime after the pump chamber is discharged but before the pump chamber has filled with liquor. This time is set as required by optimizing the nozzle orifice, the spring strength, the bypass from the flow controller, the expansion chamber size, the position of the inlet hole to the first expansion chamber 114 and the one way valve in the first expansion chamber 114. For the continuous version, the user will keep actuating the dispenser and more fluid will enter into the first expansion chamber 114 from the pump chamber and the plunger will keep moving up and downstream until the user ceases activation. The flow rate through the final orifice is configured so that the user actuates the device before the first expansion chamber 114 is emptied and more fluid flows into it before the prodder has had chance to seal the outlet hole. This moves the plunger back upstream and the process continues until the device is no longer used and any fluid in the first expansion chamber 114 is discharged. The final discharge is referred to as the after spray even though it can be a spray, foam or bolus of fluid.

The device can operate effectively without the flow controller but the flow and spray or foam may not be as consistent as with it. The flow and spray angle vary considerably, as does the droplet size and throw of the discharge. The spray orifice would normally need to be reduced to compensate for not having the flow controller.

The nozzle arrangement has to be balanced for continuous use so that the first expansion chamber 114 has enough fluid in it to keep discharging fluid between actuations of the device but not so much that the final discharge or after spray takes a long time after the user has stopped actuating. But the user can actuate the device quickly or slowly and aggressively or gently and this makes a great deal of difference to the time between actuations. Also, many people don't do full actuations and may only do say 60% plus of the discharge with each actuation. Different devices have different capacities as well so a trigger device normally delivers 1-1.5 mls per full discharge whereas a spray pump only tends to deliver 0.05-0.2 mls per full actuation. A trigger device will normally take around 0.25 seconds for an actuation and the same for the return stroke but this can vary from a cycle time of 0.4 seconds to one of around 0.8 seconds according to how hard the trigger is pulled and how much is discharged depending on if there is a full stroke used. A dispenser pump with an actuator normally takes around 0.15 seconds for an actuation and around 0.2 seconds for the return stroke and again this can vary according to the force used and if a full cycle is used. The user can also slow down the return stroke for triggers and pumps by inadvertently exerting some residual force on the devices. With a trigger an acceptable time for the device to discharge after use would be something around 0.6 seconds and certainly under 1.3 seconds because that doesn't feel unnatural to the user. But for a pump it would have to be nearer to 0.3 seconds and under 0.5 seconds. Similarly, the final discharge for the trigger and pump shouldn't be much over a normal discharge from the pump chamber. For our continuous version to work there has to be an overspray time and this has to be long enough for the user to make the next actuation. For a trigger this can be as short as 0.3 seconds to as long as 1.5 seconds and ideally it should be between 0.7-1.3 seconds once the trigger or actuator has been released. So the volume of fluid inside the chamber has to be closely controlled and that is one of the keys to this technology.

The nozzle arrangement has to accommodate a lot of variables. Clearly the nozzle arrangement would be made in different sizes with the dispenser spray pump version being much smaller than the trigger version but even allowing for that, it is difficult to achieve such control. That is why we have a variable first expansion chamber 114 and preferably a flow control device 126. The nozzle arrangement has to be configured so that even with a slow actuation and a reduced discharge there is still some fluid in the first expansion chamber 114 when the next actuation takes place. It also has to be able to ensure that there isn't too much fluid in the first expansion chamber 114 when the user does really fast and full cycles so that the fluid keeps building up in the first expansion chamber 114 and the final discharge takes too long or even the chamber cannot contain any more fluid. This can cause an enormous increase in pressure and can cause the dispenser to be damaged. At best it makes it very difficult for the user and the device can lock out so the user cannot move the actuator or trigger.

To resolve all of these different problems, the nozzle arrangement has to be carefully configured. The expansion chamber has to be big enough to ensure that there is enough fluid in the first expansion chamber 114 to keep discharging between actuations yet small enough to ensure that the overspray is minimized and preferably kept below 1.3 second and above 0.3 seconds. This is quite demanding given all the variables. The inlet valve to the first expansion chamber 114 helps to ensure that the first expansion chamber 114 stays pressurised between actuations. The spring is set to ensure that the plunger has to be moved with enough force to pull out the prodder and this stops the user actuating with too little force and minimizes the problem of short discharges and too soft actuations. Other designs use auxiliary precompression valves between the plunger and the outlet hole but these take effort to open and as we ideally only want to open the outlet hole once with the continuous version, we normally use only the prodder on the plunger although we could use both. The spring strength also ensures that the prodder seals the outlet hole until there is enough force on the fluid being discharged from the first expansion chamber 114. If the main spring is too strong then too much force is needed by the user to activate it and the discharge can be too fast to maintain enough fluid in the first expansion chamber 114. A back stop is added to the upstream end of the plunger or onto the wall of the expansion chamber so the plunger can only travel a maximum distance. This is positioned so that the first expansion chamber 114 cannot hold more fluid than can be discharged in the preset time for the after spray. Alternatively the spring could be sized so that the position is set by the maximum compression of the spring. We also position the inlet hole to the first expansion chamber 114 and the inlet valve in such a way that the combination helps to determine the maximum travel of the plunger, the maximum volume of fluid in it and the maximum pressure. In practice, we have to configure all of the various parameters to achieve the various possible configurations and we need to minimize the volume of fluid that can be delivered from the expansion chamber.

One of the main keys to the success of this nozzle arrangement is the variable discharge according to how much fluid is in the first expansion chamber 114. A standard orifice will vary in flow according to the pressure with the higher the pressure the greater the flow. It is easier to maintain enough fluid inside the first expansion chamber 114 for this to work as required but it doesn't operate in an optimal way. As the user actuates the device the pressure inside the first expansion chamber 114 can vary enormously before it settles down or if it reaches or is already at the position of maximum travel plus it causes peaks of pressure and this causes big changes in the flow from the final orifice and has a considerable impact on the foam or spray quality. With the flow control the discharge and foam or spray quality is kept within predefined limits that are acceptable to the user and the supplier of the devices. The ideal control is to keep the flow constant regardless of the pressure in the expansion chamber and this is a preferred option. But something like a flow range of 15-30% and preferable around 20% is barely noticeable to the user and makes controlling the after spray duration easier. The advantage of no flow control is that the fuller the first expansion chamber 114, the higher the pressure and the faster the flow and this makes it much easier to control the volume and pressure of the fluid in the first expansion chamber 114. With a constant flow the users who activate the device aggressively will rapidly fill the first expansion chamber 114 and cause the pressure to increase substantially so it becomes difficult to control the quality of the discharge and the after spray. By allowing the flow to increase by say 20% from the first expansion chamber 114 being nearly empty to almost full it is easier to prevent the chamber from either emptying or overfilling or over pressurizing yet the quality of the discharge is consistent enough. So if a user makes fairly slow actuations the first expansion chamber 114 will tend to go low in volume and pressure during use and the discharge will reduce giving the user longer between actuations and still retaining the continuous flow. With fast actuations the chamber will tend to hold more fluid so the pressure will be higher because the plunger spring is compressed more and this makes the discharge faster helping to prevent the first expansion chamber 114 from becoming full. But the flow difference is not so great that the performance is adversely affected. Ideally, the flow control is set to control the flows within 20% regardless of the pressure and for some applications within 10%.

But even this control is not enough as if the user actuates too slowly there will be no fluid left in the chamber between actuations and it will stop discharging. If the user actuates too fast then the first expansion chamber 114 could fill and the pressure will quickly build up probably causing the device to fail or at least making it difficult to actuate. But careful design of the various parameters and especially the position of the inlet hole 139 in relation to the plunger seal 116 should ensure that this is no problem. It may be possible that the discharge from the pump is so large and there is only enough space for a small expansion chamber and then the pressure could become too high in certain instances. To overcome that we either add a valve to the first expansion chamber 114 that opens when a set high pressure is reached and allows excess fluid in the first expansion chamber 114 to go to the pump chamber or the container, or we configure the outlet valve 109 from the container to open at that set pressure to allow any excess fluid back into it, or a combination of these. A preferred solution is to make the inlet valve to the first expansion chamber 114 to open at a set position and then to make the inlet valve following the diptube to open at what would be a higher set pressure. This is to ensure that the excess fluid preferentially goes back to the pump chamber and if that option isn't enough it goes to the container. Any suitable type of valve could be used and the drawings show one such type. But the plunger valve shown in our preferred configuration is more than just a high pressure valve as it opens once the fluid volume in the first expansion chamber 114 has reached its set maximum volume. This means that because we control the valve opening by the volume rather than the pressure in most cases we avoid the pressure going so high that it can damage the device and adversely affect the spray of foam. The pressure in the first expansion chamber 114 will equal that in the rest of the device upstream of the expansion chamber once the valve is open and if the pump chamber is delivering more fluid then the pressure will rise until the pressure exceeds the limit of the inlet pressure valve following the diptube and that will open and allow a controlled amount of fluid to flow back to the container until the first expansion chamber 114 valve covers the inlet hole. If the pump chamber is drawing in fluid then fluid from the first expansion chamber 114 will flow to the pump chamber until the first expansion chamber 114 inlet hole is covered by the valve. If everything is configured correctly then the fluid will rarely flow back to the container and the upper pressure limit in the expansion chamber will be controlled within the set limits. So a preferred configuration doesn't have an additional pressure release valve to the container and relies on the position of inlet hole to the first expansion chamber.

Preferably, the high pressure should be between 7-12 bars and more preferably between 7 and 9 bars. It is quite possible to manage without this valve and ideally, everything is configured so it isn't normally used, but having it enables a smaller volume of fluid to be contained in the first expansion chamber 114 and hence a more precise over spray time window to be achieved as that has to cater for the worst possible situation. But it isn't set so low that fluid is often pumped back as that wastes too much effort by the user. So the high pressure valve is a fail safe device that enables a smaller window of fluid volume to be held in the expansion chamber than would otherwise be possible. In turn, this enables a smaller window of pressure and the time of the after spray to be achieved. Clearly, the spring pressure is also configured to optimize the low pressure setting of the fluid in the first expansion chamber 114 and this is also an essential part. We show the expansion chamber in a horizontal position as this is the cheapest and simplest way to make the device especially if many of the components of a standard trigger dispenser are used. Also, this means that we don't use an additional chamber but rather simply expand part of the outlet route. But it could be set in a vertical orientation with part of the expansion chamber extending down and even inside the container. This would make it simple to discharge any excess fluid back into the container direct from a valve in the expansion chamber. It is also possible to add a tube extension from the expansion chamber of the preferred design to the container direct so that once the plunger had moved far enough upstream the fluid could flow back into the container via a one way valve. This could be instead of or as well as to the pump chamber.

If the user actuates too slowly with the continuous spray version then as mentioned, the device will stop discharging sometime between actuations. The parameters are optimized for slow actuations that are comfortable for most users but it will only go so far and that is a weakness of this device compared to the standard continuous dispensers that use pressurized air to discharge the liquor. So it is important that each actuation causes a discharge rather than the user having to actuate the device a number of times once it has stopped. Sometimes people only want to make one or sporadic discharges and this works well for that as the discharge preferably begins with the first actuation and there is no need to pump up a chamber in advance.

The force needed to actuate the device has to be minimized for the user and this is determined by the precompression valve setting, the discharge volume, the diameter of the pump chamber, the length of the handle and the diameter and length of the first expansion chamber. The precompression is normally set between 3 and 5 bars with 4 bars being common. The discharge volume usually varies up to a maximum of 1.5 mls. The length of the handle is largely fixed because of limitations caused by the shape of the container making a long handle almost impossible. The diameter of the pump chamber is usually 14 mm or less as any more and the force is too high. The diameter and length of the first expansion chamber determine how much fluid can be stored there and the time and volume of the over spray. In practice if the first expansion chamber diameter is over 10 mm then the actuation force is too high and we have found that under 10 mm dia is preferable. The length of the chamber is limited by the shape of the device and the need for it to go through automatic assembly and filling lines. Also, the longer the chamber the more the spring is tensioned and the greater the actuation force. So, if the total maximum volume stored inside the first expansion chamber is less or not much more than the volume discharged by the pump chamber, it is practical to add the expansion chamber to current triggers and pumps and the actuation force is acceptable. It is greatly preferred to have the inlet hole 139 in the expansion chamber though and ideally this is positioned so the volume contained in the chamber downstream of the hole is around 80%-120% of the pump chamber discharge volume. It needs to be more than 60% to be able to maintain a continuous discharge and less than 130% so the discharge isn't too long and also so the expansion chamber isn't too long. It is possible to make a different or additional expansion or storage chamber but it is preferable to use the standard route from the pump chamber to the outlet nozzle as this makes everything cheaper and more compact.

All dispensers and triggers have an outlet nozzle of some description and the type and shape determine if the fluid is delivered as a spray, foam or bolus of fluid. Spray and often foam nozzles are often preceded by a precompression valve and there are numerous types of these valves. Essentially, they only open allowing the fluid to pass once a sufficiently high pressure has been reached and they then open and allow the fluid to pass to the outlet nozzle. So it the user isn't pressing or pulling hard enough the devices won't work. The advantage of them is that the spray or foam is superior and the disadvantages are that the device is more complicated with more parts and is costlier plus it takes more effort to open the valve and to keep it open so the user has to use more effort. The valve is normally but not always close to or next to the outlet nozzle after the pump chamber. To incorporate our device into theirs, the outlet nozzle and precompression valve are removed and the nozzle arrangement is joined to the outlet pipe following the pump chamber. This is much easier with some designs with little extra tooling and a sub assembly needed for our nozzle arrangement and this is especially true of spray pumps and dispensers where it is often just a matter of replacing their actuator with ours. It tends to be more complicated with triggers but even then most of the existing trigger device is retained. Clearly, our nozzle arrangement can be incorporated into any continuous dispenser actuated by an actuator or trigger handle.

Any trigger device would benefit from having a flow control including a standard trigger that does a single discharge per actuation. This is because the quality of the discharge still varies according to how hard or gently the actuator is pulled and the flow control will help to even out the performance over the stroke. Similarly, the continuous triggers using compressed air would also benefit from the enhanced performance with a flow controller. So we will split the patent to include any trigger device and a flow controller.

Similarly, using a high volume control will be patented with any continuous trigger including those with pressurized containers as this will increase the level of control achievable with those devices. Using both a flow control and a high volume control is even more preferred.

The drawings and descriptions have focussed on dispensers actuated by a trigger rather than an actuator simply because the applications for them are far greater. But the mechanics are essentially the same except instead of pulling a handle in to move the pump plunger; the user pushes down on the actuator to move the pump plunger. Normally, the expansion chamber will be horizontal inside the actuator although it could be vertical and the configuration will be substantially the same.

Whereas the invention has been described in relation to what is presently considered to be the most practical and preferred embodiments, it is to be understood that the invention is not limited to the disclosed arrangements but rather is intended to cover various modifications and equivalent constructions included within the spirit and scope of the invention.

The present invention may provide a nozzle arrangement adapted for a manually operated pump dispenser that is activated by an actuator or a trigger handle for dispensing a fluid from a container as an atomised spray or a foam, the nozzle arrangement converting the pumped or intermittent discharges from the dispenser into an extended discharge that continues after the actuation stroke of the pump dispenser, whereby the nozzle arrangement is positioned downstream of the pump chamber of the dispenser and comprises an expansion chamber with a variable storage capacity for the fluid, an outlet downstream of the expansion chamber, a moveable plunger inside that chamber that is tensioned by a resiliently deformable component such as a spring and that moves further upstream as the expansion chamber fills with fluid.

In an embodiment, the nozzle arrangement may be configured such that the discharge from the device may continue after 20%, 50%, 90%, 100% of the return stroke of the dispenser pump.

The discharge from the device may be continuous.

The nozzle arrangement may be configured such that the discharge time after the pump return stroke ends is less than 0.4, 0.6, 0.8, 1, 1.3 seconds.

In an embodiment, fluid may be discharged from the final orifice before the end of the second actuation of the pump.

Fluid may be discharged from the final orifice during the first actuation of the pump.

The moveable plunger inside the expansion chamber may have a downstream end that seals off the outlet of the expansion chamber in the off position.

In an embodiment, the or a spring or resiliently deformable element may prevent the plunger from moving to an unsealing position until a set pressure has been reached to allow fluid to escape from the expansion chamber.

The diameter of the expansion chamber may be smaller than that of the pump chamber. The diameter of the expansion chamber may be less than 10 mm.

In an embodiment, the expansion chamber may be provided by an expansion of the outlet route and not a new chamber.

The inlet to the expansion chamber may be fluidly connected to the outlet from the pump chamber and there may be a valve between said chambers that allows some fluid to flow from the expansion chamber back to the pump chamber or the container once a set pressure has been exceeded.

There may be a valve between the two chambers that allows some fluid to flow back from the expansion chamber to the pump chamber or the container once the plunger has moved upstream to a set position.

The inlet valve to the expansion chamber may be part of the plunger in the expansion chamber and may be a one way valve.

When the plunger has moved upstream to a preset position the plunger valve may no longer protect the inlet hole to the expansion chamber and fluid in the expansion chamber may be able to flow back to the pump chamber or container.

The plunger resiliently deformable component such as a spring or a restriction in the expansion chamber may determine the maximum upstream movement of the plunger to a position upstream of where the inlet valve to the expansion chamber is open.

There may be a maximum storage capacity for fluid in the expansion chamber that is at least partly determined by the maximum upstream travel of the plunger.

There may be a maximum useable capacity for fluid in the expansion chamber that is less than 3 times, 2 times, 1 time the capacity of the pump chamber.

There may be a valve on the inlet from the container that allows some fluid to be pumped back from the pump chamber to the container once a set pressure has been exceeded. Preferably, the set pressure may be over 7 bars.

The invention may provide a nozzle arrangement adapted for a manually operated pump dispenser that is activated by an actuator or a trigger handle for dispensing a fluid from a container as an atomised spray or a foam, the nozzle arrangement converting the pumped or intermittent discharges from the dispenser into an extended discharge that continues after the actuation stroke of the pump dispenser, wherein the nozzle arrangement has a flow controller that controls the flow as the pressure of the fluid varies.

The nozzle arrangement may be configured to provide a continuous discharge of fluid.

The rate of flow of the fluid out of the or a final orifice can be controlled by a flow controller that is upstream of the final outlet orifice and downstream of the pump chamber.

The flow controller may be upstream of the final outlet orifice and downstream of an expansion chamber.

The flow controller may be operable to open after use to clear any blockage.

The rate of flow of the fluid out of the final orifice can be controlled by a flow controller and the flow of the fluid through it may vary by less than 60%, 30%, 20%, 10% regardless of the pressure.

The flow controller may comprise a resiliently deformable component in contact with the or an edge of the chamber outlet hole whereby a partial seal is formed between the two.

The edge of the outlet hole may be deformed, shaped or textured in such a way that the resiliently deformable part increasingly reduces the gaps and the flow of the fluid between them with increasing pressure but never fully closes the gaps so there is always flow through it.

The or an edge of the outlet hole may be deformed, shaped or textured in such a way that the flow past it increases with increasing pressure but in a non-linear way.

There may be a second outlet route between the pump chamber and final orifice that bypasses the flow controller.

According to a variable configuration, the fluid may flow, in use, through only the flow controller, only the bypass hole, through both or be closed off

The route the fluid flows, in use, may be determined by the position of the outlet nozzle.

The final orifice may be preceded by a swirl and a finial orifice to create a spray. The final orifice may be preceded by a swirl and a finial orifice and a tube to create a foam. The final orifice may be preceded by a swirl and a finial orifice and a mesh to create a foam.

At least part of the outlet nozzle may be movable into two or more different positions that enable different types of discharges to be delivered.

The outlet nozzle may have one or more orifices plus one or more different flow paths set so that when the nozzle is moved into position only one flow path and orifice combination allows fluid to pass through.

The outlet nozzle may have two or more different orifices set off centre so that when the nozzle is moved each can become the only active discharge orifice.

At least one of the orifices may produce a continuous spray or foam and at least one other produces a standard or non-continuous spray or foam.

In an embodiment, at least one orifice that produces a continuous flow may be preceded by a flow controller and at least one orifice that produces a non-continuous or standard spray or foam may be at least partially fed from a route that bypasses the flow controller.

The invention may also provide a method of manufacture or assembly of a device (e.g. a nozzle arrangement and/or a fluid dispenser) according to the invention. The invention may also provide a kit of parts for the manufacture or assembly of a device according to the invention. The invention may further provide a package or point-of-sale display comprising one or more, preferably a plurality of, devices according to the invention.

1-49. (canceled)

50. A nozzle arrangement adapted for a pump dispenser, e.g. a manually-operated pump dispenser, that is activated by an actuation stroke of an actuator or a trigger handle to dispense a fluid from a container as a spray, e.g. an atomised spray, a foam, a gel, a paste or a liquid, wherein the nozzle arrangement is positioned downstream of, and in fluid communication with, a pump chamber of the dispenser and the nozzle arrangement comprises: an expansion chamber having an inlet and an outlet; and a movable plunger disposed within the expansion chamber, the movable plunger being arranged such that it can move, in use, in an upstream and downstream direction to vary the volume of the expansion chamber, wherein the plunger is biased by a resiliently deformable component such as a spring, the resiliently deformable component providing a biasing force in the downstream direction; wherein, in use, the actuation stroke causes the fluid to enter the expansion chamber at a faster rate than the fluid can be discharged from the expansion chamber via the outlet, whereby a pressure build-up within the expansion chamber pushes the plunger in the upstream direction against the biasing force provided by the resiliently deformable component such that fluid entering the expansion chamber is discharged via the outlet during the actuation stroke and after the actuation stroke, due to the biasing force provided by the resiliently deformable component causing the plunger to move in the downstream direction, thereby causing fluid to be discharged via the outlet, wherein the outlet from the expansion chamber is in fluid communication with at least one final orifice, the nozzle arrangement further comprising a flow controller disposed downstream of the pump chamber and upstream of the outlet or the final orifice(s), the flow controller being configured to regulate the flow as the pressure varies.

51. A nozzle arrangement according to claim 50, in which: the movable plunger has a downstream end that seals off the outlet in an off or a rest position; and/or the nozzle arrangement comprises a valve that is configured to allow some fluid to flow from the expansion chamber to the pump chamber or the or a container once a set volume has been exceeded; and/or the expansion chamber is configured to have a maximum storage capacity for fluid that is less than three times the capacity of the pump chamber; and/or the nozzle arrangement is configured such that the rate of flow of the fluid out of the outlet or at least one final orifice is less than ⅓ of the rate of flow of the fluid from the pump chamber into the expansion chamber; and/or the flow controller comprises a resiliently deformable component in contact with the or an edge of the outlet, whereby a partial seal is formed between the resiliently deformable component and the edge of the outlet.

52. A nozzle arrangement according to claim 50, the nozzle arrangement is configured to provide an extended and/or continuous discharge, which lasts for more than 0.3 seconds after the actuation stroke and/or wherein the nozzle arrangement is configured to provide an extended and/or continuous discharge, which lasts for less than or more than 1.3 seconds after the actuation stroke.

53. A nozzle arrangement according to claim 50, further comprising an adaptor disposed downstream of the outlet, the adaptor being operable in a first position to enable the nozzle arrangement to discharge the fluid as a continuous and/or extended spray or foam, and in a second position to enable the nozzle arrangement to discharge the fluid as a standard or non-continuous spray or foam, optionally wherein the adaptor is movable, e.g. rotatable, from the first position to the second position and vice versa.

54. A nozzle arrangement according to claim 50, wherein: the discharge from the device continues after 20%, 50%, 100% of the return stroke of the dispenser pump; and/or fluid is discharged from the or a final orifice before the end of a second actuation of the pump; and/or fluid is discharged from the or a final orifice during the first actuation of the pump.

55. A nozzle arrangement according to claim 50, wherein at least one of the following applies:
(a) there is a spring or resiliently deformable element preventing the plunger from moving to an unsealing position until a set pressure has been reached to allow fluid to escape from the expansion chamber to the container or the pump chamber;
(b) the diameter of the expansion chamber is smaller than that of the pump chamber;
(c) the expansion chamber is an expansion of the outlet route between the pump chamber and the final orifice and not a separate chamber;
(d) there is a valve between the pump chamber and the expansion chamber that allows some fluid to flow back from the expansion chamber to the pump chamber or the container once the plunger has moved upstream to a set position;
(e) an inlet valve to the expansion chamber is part of the plunger in the expansion chamber and is a one way valve;
(f) when the plunger has moved upstream to a preset position the plunger valve no longer protects the inlet hole to the expansion chamber and fluid in the expansion chamber can flow back to the pump chamber or container;
(g) the plunger spring or a restriction in the expansion chamber determines the maximum upstream movement of the plunger to a position upstream of where the inlet valve to the expansion chamber is open;
(h) there is a maximum storage capacity for fluid in the expansion chamber that is at least partly determined by the maximum upstream travel of the plunger;
(i) there is a valve on the inlet from the container that allows some fluid to be pumped back from the pump chamber to the container once a set pressure has been exceeded, optionally wherein the set pressure is over 7 bars.

56. A nozzle arrangement adapted for a pump dispenser that is activated by an actuator or a trigger handle for dispensing a fluid from a container as an atomised spray or a foam, the nozzle arrangement producing an extended discharge that continues after the actuation stroke of the pump dispenser, wherein the nozzle arrangement has a flow controller that controls the flow as the pressure of the fluid varies, optionally wherein the discharge is continuous.

57. A nozzle arrangement according to claim 50, wherein at least one of the following applies:
(a) the rate of flow of the fluid out of the final orifice can be controlled by a flow controller that is upstream of the final outlet orifice and downstream of the pump chamber;
(b) the or a flow controller is upstream of the final outlet orifice and downstream of an expansion chamber;
(c) the or a flow controller can open after use to clear any blockage;
(d) the rate of flow of the fluid out of the or a final orifice can be controlled by a flow controller and the flow of the fluid through it varies by less than 30%, 20%, 10% regardless of the pressure;
(e) the or a flow controller comprises a resiliently deformable component in contact with the edge of the chamber outlet hole whereby a partial seal is formed between the two, optionally wherein the edge of the outlet hole is deformed, shaped or textured in such a way that the resiliently deformable part increasingly reduces the gaps and the flow of the fluid between them with increasing pressure but never fully closes the gaps so there is always flow through it, optionally wherein the edge of the outlet hole is deformed, shaped or textured in such a way that the flow past it increases with increasing pressure but in a non-linear way.

58. A nozzle arrangement according to claim 50, wherein there is a second outlet route between the pump chamber and final orifice that bypasses the flow controller and/or wherein according to the variable configuration, the fluid can flow through only the or a flow controller, only the or a bypass hole, through both or be closed off.

59. A nozzle arrangement adapted for a pump dispenser that is activated by an actuator or a trigger handle for dispensing a fluid from a container as an atomised spray or a foam, the nozzle arrangement converting the pumped or intermittent discharges from the dispenser into an extended discharge that continues after the actuation stroke of the pump dispenser, wherein the nozzle arrangement further comprising an adaptor disposed downstream of the outlet, the adaptor being operable in a first position to enable the nozzle arrangement to discharge the fluid as a continuous and/or extended spray or foam, and in a second position to enable the nozzle arrangement to discharge the fluid as a standard or non-continuous spray or foam, optionally wherein the route the fluid flows is determined by the position of an outlet nozzle.

60. A nozzle arrangement according to claim 50, wherein at least one of the following applies:
(a) at least part of the or an outlet nozzle can be moved into two or more different positions that enable different types of discharges to be delivered;
(b) the or an outlet nozzle has one or more orifices plus one or more different flow paths set so that when the nozzle is moved into position only one flow path and orifice combination allows fluid to pass through;
(c) the or an outlet nozzle has two or more different orifices set off centre so that when the nozzle is moved each can become the only active discharge orifice;
(d) at least one of the orifices produces a continuous spray or foam and at least one other produces a standard or none continuous spray or foam;
(e) at least one orifice that produces a continuous flow is preceded by a flow controller and at least one orifice that produces a non-continuous or standard spray or foam is at least fed from a route that bypasses the flow controller.

61. A fluid dispenser comprising a nozzle according to claim 50.

62. A fluid dispenser according to claim 61, wherein the dispenser comprises a container, optionally wherein the container is a non-pressurised container.

63. A fluid dispenser according to claim 62, wherein the container contains a fluid, optionally wherein the fluid comprises tooth paste, antiperspirant, de-odorant, perfume, air freshener, antiseptic, paint, insecticide, pesticide, polish, a hair care product, a pharmaceutical, shaving gel or foam, water or lubricant.
